(19) United States
(12) Patent Application Publication
(10) Pub. No.: US 2014/0173556 A1
(43) Pub. Date: Jun. 19, 2014

(54) SYSTEMS AND METHODS FOR SELECTION OF SPECIALIZED FUNCTIONS IN DYNAMICALLY-TYPED LANGUAGES

(71) Applicant: QUALCOMM Incorporated, San Diego, CA (US)

(72) Inventors: Behnam Robatmili, San Diego, CA (US); Derek Jay Conrod, San Diego, CA (US); Mohammad Hossein Reshadi, San Diego, CA (US); Subrato Kumar De, San Diego, CA (US); Gheorghe Calin Cascaval, Palo Alto, CA (US)

(73) Assignee: QUALCOMM Incorporated, San Diego, CA (US)

(21) Appl. No.: 14/083,264

(22) Filed: Nov. 18, 2013

Related U.S. Application Data
(60) Provisional application No. 61/738,323, filed on Dec. 17, 2012.

(51) Int. Cl. G06F 9/44

(52) U.S. Cl. CPC G06F 8/31
USPC 717/115

(57) ABSTRACT

Systems, methods, and devices for executing a function in a dynamically-typed language are described herein. In one aspect, a method includes generating a function selection decision tree based on one or more specializations of a generic function and one or more function inputs via an electronic device. The method further includes selecting one of the specializations or the generic function based on an input type of at least one function input via the electronic device. The method further includes calling the selected specialization or generic function via the electronic device. Another aspect of the subject matter described in the disclosure provides a method of executing a function in a prototype-based dynamically-typed language. The method includes maintaining a list of calls to one or more specializations of the function via the electronic device. The method further includes creating or destroying a specialization of the function via the electronic device. The method further includes updating calls to the created or destroyed specialization via the electronic device. Advantageously in certain embodiments, selection logic overhead can be reduced using criteria that can utilize different weightages for one or more inputs based on heuristics or runtime information.

### CROSS-REFERENCE TO RELATED APPLICATIONS

The present application claims priority to provisional U.S. Application Ser. No. 61/738,323, entitled “Systems and Methods for Selection of Specialized Functions in Dynamically-Typed Languages,” filed Dec. 17, 2012, assigned to the assignee hereof and incorporated herein by reference in its entirety.

### FIELD

This application relates generally to computing devices, and more particularly to methods for executing dynamic languages on computing devices.

### BACKGROUND

Dynamic scripting languages are presently a preferred development platform in computer programming and software development. In particular, JavaScript® is the main development language for web pages and web applications on the client side, while Python and Ruby are very popular languages for software development on the server side. Such programming languages are designed for interactive execution (scripting), and are thus, by necessity, dynamic (i.e., support dynamic types, reflection and introspection, and extensibility). Dynamic scripting languages typically execute via interpretation, in which, at runtime, the scripts are parsed and analyzed before they are executed.

Recently, just-in-time compilation has been introduced for a number of these languages, such as JavaScript, to address performance issues of dynamic languages. However, performance problems persist. This is particularly the case in constrained computing environments, such as a mobile device, where the performance and power efficiency of executing dynamic languages continue to be at issue.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include reducing overheads of signature-based function specialization.

One aspect of the subject matter described in the disclosure provides a method of executing a function in a prototype-based dynamically-typed language. The method includes generating a function selection decision tree based on one or more specializations of a generic function and one or more function inputs via an electronic device. The method further includes selecting one of the specializations or the generic function based on an input type of at least one function input via the electronic device. The method further includes calling the selected specialization or generic function via the electronic device.

Another aspect of the subject matter described in the disclosure provides a method of executing a function in a prototype-based dynamically-typed language. The method includes maintaining a list of calls to one or more specializations of the function via an electronic device. The method further includes creating or destroying a specialization of the function via the electronic device. The method further includes updating calls to the created or destroyed specialization via the electronic device.

Another aspect of the subject matter described in the disclosure provides a device configured to execute a function in a prototype-based dynamically-typed language. The device includes a memory. The device further includes a processing circuit configured to generate a function selection decision tree based on one or more specializations of a generic function and one or more function inputs. The processing circuit is further configured to select one of the specializations or the generic function based on an input type of at least one function input. The processing circuit is further configured to call the selected specialization or generic function.

Another aspect of the subject matter described in the disclosure provides a device configured to execute a function in a prototype-based dynamically-typed language. The device includes a memory. The device further includes a processing circuit configured to maintain a list of calls to one or more specializations of the function. The processing circuit is further configured to create or destroy a specialization of the function. The processing circuit is further configured to update calls to the created or destroyed specialization.

Another aspect of the subject matter described in the disclosure provides an apparatus for executing a function in a prototype-based dynamically-typed language. The apparatus includes means for generating a function selection decision tree based on one or more specializations of a generic function and one or more function inputs. The apparatus further includes means for selecting one of the specializations or the generic function based on an input type of at least one function input. The apparatus further includes means for calling the selected specialization or generic function.

Another aspect of the subject matter described in the disclosure provides an apparatus for executing a function in a prototype-based dynamically-typed language. The apparatus includes means for maintaining a list of calls to one or more specializations of the function. The apparatus further includes means for creating or destroying a specialization of the function. The apparatus further includes means for updating calls to the created or destroyed specialization.

Another aspect of the subject matter described in the disclosure provides a non-transitory computer-readable medium including code that, when executed, causes an apparatus to generate a function selection decision tree based on one or more specializations of a generic function and one or more function inputs. The medium further includes code that, when executed, causes the apparatus to select one of the specializations or the generic function based on an input type of at least one function input. The medium further includes code that, when executed, causes the apparatus to call the selected specialization or generic function.

Another aspect of the subject matter described in the disclosure provides a non-transitory computer-readable medium including code that, when executed, causes an apparatus to maintain a list of calls to one or more specializations of the function. The medium further includes code that, when executed, causes the apparatus to create or destroy a specialization of the function. The medium further includes code that, when executed, causes the apparatus to update calls to the created or destroyed specialization.

### BRIEF DESCRIPTION OF THE DRAWINGS

FIG. 1 illustrates an example of a wireless communication system in which aspects of the present disclosure can be employed.

FIG. 2 shows a functional block diagram of an exemplary wireless device that can be employed within the wireless communication system of FIG. 1.

FIG. 3 shows an exemplary decision tree that can be implemented on the device of FIG. 2.

FIG. 4 shows a flowchart 400 of an aspect of an exemplary method of executing a function.

FIG. 5 is a functional block diagram of an exemplary computing device that can implement the method of FIG. 4.

FIG. 6 shows an exemplary type-check process flow, according to an embodiment.

FIG. 7 shows a flowchart of an aspect of an exemplary method of generating the decision tree of FIG. 3.

FIG. 8 is a functional block diagram of an exemplary computing device that can implement the method of FIG. 7.

FIG. 9 shows a signature-based type specialization system without direct call sites.

FIG. 10 shows a signature-based type specialization system with direct call sites.

FIG. 11 shows a flowchart of an aspect of an exemplary method of executing a function.

FIG. 12 is a functional block diagram of an exemplary computing device that can implement the method of FIG. 11.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The terms “computing device” is used generically herein to refer to any one or all of servers, personal computers, mobile devices, cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, personal computers and similar personal electronic devices which include a programmable processing circuit. While the various aspects are particularly useful in mobile devices, such as cellular telephones, which have limited processing power, the aspects are generally useful in any computing device that executes scripts and applications written in dynamic and/or scripting languages.

The terms “dynamic language,” “dynamically-typed language,” and “scripting language” are used generically and interchangeably in this application and may refer to any dynamic language, scripting language, or to any interpreted language used to write programs (herein as “scripts”) that are interpreted and/or compiled at runtime. These terms may also refer to any language that runs on a managed runtime and is dynamically compiled. Thus, for the purposes of this application, the terms “dynamic language,” “dynamically-typed language,” and “scripting language” should not be limited to languages that are interpreted from source code, an intermediate representation, or bytecode, or to those that execute along with programs that are traditionally compiled into native machine code. Examples of dynamic and scripting languages within the scope of this application include, for example, JavaScript, Perl, Python and Ruby, as well as other languages that may be developed in the future. Nevertheless, a person having ordinary skill in the art will appreciate that certain embodiments may be compatible only with languages that implement dynamic typing. Moreover, certain embodiments discussed herein are particularly applicable to implementations that compile code at runtime, for example using a just-in-time (JIT) compiler.

In static computer programming languages, an off-line compiler parses an entire program and generates an intermediate representation (IR) to represent the program structure. This IR typically carries extra information, such as annotations on the abstract syntax tree, which is used at code generation time to analyze the program to determine the parts of the program that are to be executed as well as the parts that are not to be executed in this activation (i.e., code that will never be executed because it is not reachable on any path from start to end of the program in the current implementation or activation circumstance). For ease of reference, all types of such annotations are referred to herein as metadata.

In dynamically-typed languages, such as JavaScript, the parsing and compilation occurs at run-time, just before program execution. Parsing is the process of analyzing a text to determine its grammatical structure with respect to a given formal grammar, and in the interpretation of programs, parsing includes reading in the source script and converting it into an intermediate representation based on the language semantics of the program language. For most dynamic and/or scripting languages, parsing generates an intermediate representation of the program that is fed into an interpreter. The interpreter executes the intermediate representation, which can include bytecode. In some implementations, the interpreter may also invoke a just-in-time (JIT) compiler to generate machine code for selected portions of the code (such as functions). Therefore, the parsing and compilation processing time become part of the overall program execution time.

In dynamically typed languages, the type of inputs passed to each invocation of a function may change at runtime. Consequently, an optimizing JIT compiler that generates specialized code for functions, can conservatively assume the types of inputs are unknown and produce generic code, or can generate specialized code that is guarded by additional type checks. In some implementations, conservative assumptions and additional type checks can limit the performance of frequently called functions, even those called with a small number of unique input types.

In some embodiments, a processing circuit can dynamically generate multiple implementations of a frequently called function (specializations), each of which can be optimized to handle specific types of input. Each specialization can have a type signature associated with it, indicating the types of the input parameters for the specialized function. Each specialization can be associated with one of the type signatures dynamically observed for the function.

In various embodiments, the signatures and the specialized functions can be generated in different ways. In some embodiments, the processing circuit can generate the signatures and specialized functions using runtime type profiling data and static type inference. Particularly, the processing circuit can generate several signatures per function and select a specialization based on argument type. In some embodiments, the overhead of specialization selection can outweigh the benefits of signature-based specialization. Various embodiments discussed herein can reduce the overhead of signature-based optimization.

In various embodiments, the systems and methods discussed herein can be implemented within a wireless network. Wireless network technologies can include various types of wireless local area networks (WLANs). A WLAN can be used to interconnect nearby devices together, employing widely used networking protocols. The various aspects described herein can apply to any communication standard, such as WiFi or, more generally, any member of the IEEE 802.11 family of wireless protocols. For example, the various aspects described herein can be used as part of the IEEE 802.11ah protocol, which uses sub-1 GHz bands.

In some implementations, a WLAN includes various devices which are the components that access the wireless network. For example, there can be two types of devices: access points (“APs”) and clients (also referred to as stations, or “STAs”). In general, an AP serves as a hub or base station for the WLAN and an STA serves as a user of the WLAN. For example, an STA can be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA can also be used as an AP.

An access point (“AP”) can also include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein can implement the 802.11ah standard, for example. Such devices, whether used as an STA or AP or other device, can be used for smart metering or in a smart grid network. Such devices can provide sensor applications or be used in home automation. The devices can instead or in addition be used in a healthcare context, for example for personal healthcare. They can also be used for surveillance, to enable extended-range Internet connectivity (e.g., for use with hotspots), or to implement machine-to-machine communications.

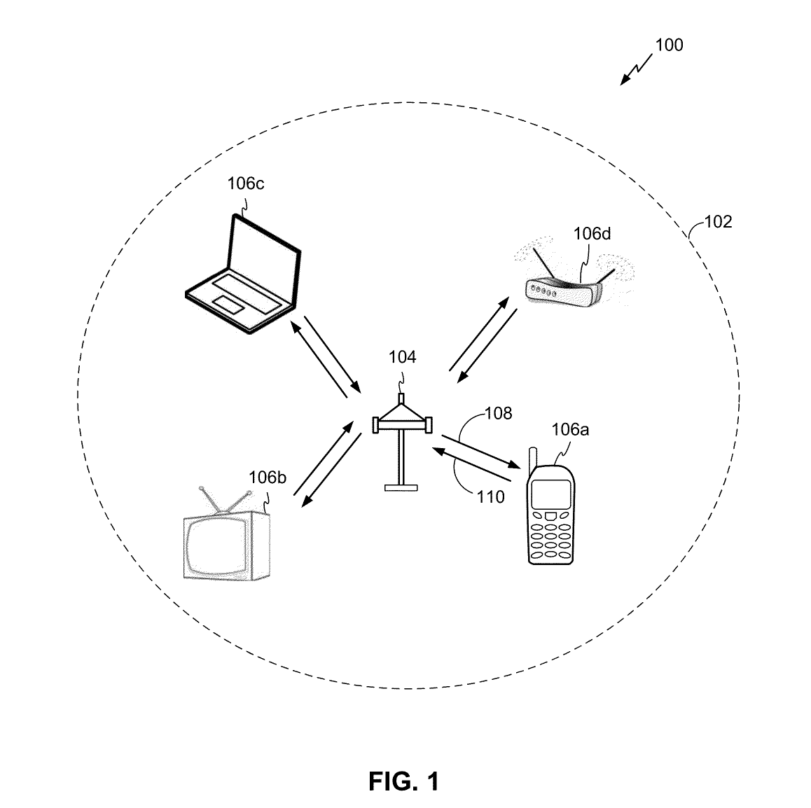

FIG. 1 illustrates an example of a wireless communication system 100 in which aspects of the present disclosure can be employed. The wireless communication system 100 can operate pursuant to a wireless standard, for example the 802.11ah standard. The wireless communication system 100 can include an AP 104, which communicates with STAs 106.

A variety of processes and methods can be used for transmissions in the wireless communication system 100 between the AP 104 and the STAs 106. For example, signals can be sent and received between the AP 104 and the STAs 106 in accordance with OFDM/OFDMA techniques. If this is the case, the wireless communication system 100 can be referred to as an OFDM/OFDMA system. Alternatively, signals can be sent and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

In various embodiments, the STAs 106 can be low-power devices, such as networked sensors with limited access to power. For example, the STAs 106 can be battery-powered devices. In various embodiments, the AP 104 can transmit packets encoded such that the STAs 106 can quickly determine when they are not the addressee of a packet. When the STAs 106 determine that they are not the addressee of a packet, they can stop decoding the packet, shut down one or more components (such as a receiver, for example), and/or enter a low-power state. When in the low-power state, the STAs 106 can consume less power than when determining whether they are the addressee of a packet. In an embodiment, the AP 104 can transmit packets having various preamble lengths depending on a packet type. When the STAs 106 receive packets having a short preamble length, they can transition to the low-power state sooner, having received the packet in less time.

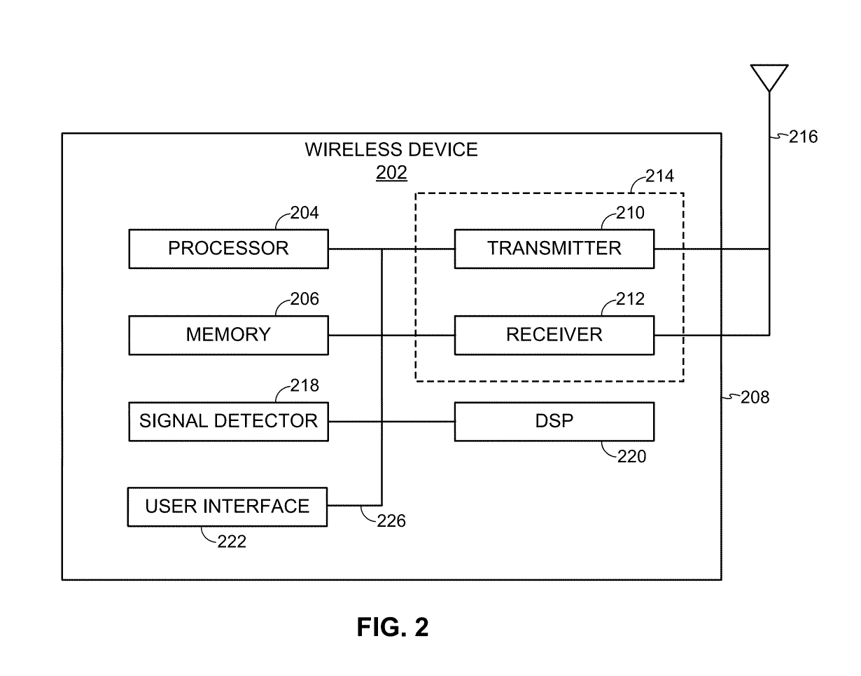

FIG. 2 illustrates various components that can be utilized in a wireless device 202 that can be employed within the wireless communication system 100. The wireless device 202 is an example of a device that can be configured to implement the various methods described herein. For example, the wireless device 202 can include the AP 104 or one of the STAs 106. Although systems and methods are discussed herein with respect to wireless devices, a person having ordinary skill in the art will appreciate that the systems and methods can be used in conjunction with any computing device.

The wireless device 202 can include a processing circuit 204 which controls operation of the wireless device 202. The processing circuit 204 can also be referred to as a central processing unit (CPU). Memory 206, which can include both read-only memory (ROM) and random access memory (RAM), provides instructions and data to the processing circuit 204. A portion of the memory 206 can also include non-volatile random access memory (NVRAM). The processing circuit 204 typically performs logical and arithmetic operations based on program instructions stored within the memory 206. The instructions in the memory 206 can be executable to implement the methods described herein.

The processing circuit 204 can include or be a component of a processing system implemented with one or more processing circuits. The one or more processing circuits can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processing circuits, cause the processing system to perform the various functions described herein. Furthermore, systems and methods in accordance with specific embodiments can be resident within and implementable by a Virtual Machine, a JIT compiler, an Interpreter, or any technology involved in compiling and executing programs implemented in a prototype-based dynamically typed languages, such as but not limited to a processing circuit 204 illustrated in FIG. 2. Additionally, the processing circuit 204 can be utilized to generally describe an overall execution environment implemented in particular embodiments.

The wireless device 202 can also include a housing 208 that can include a transmitter 210 and a receiver 212 to allow transmission and reception of data between the wireless device 202 and a remote location. The transmitter 210 and the receiver 212 can be configured to operate in one or more power states.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can include a physical layer data unit (PPDU). In some aspects, the PPDU is referred to as a packet.

The wireless device 202 can further include a user interface 222 in some aspects. The user interface 222 can include a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components are illustrated in FIG. 2, those of skill in the art will recognize that one or more of the components can be combined or commonly implemented. For example, the processing circuit 204 can be used to implement not only the functionality described above with respect to the processing circuit 204, but also to implement the functionality described above with respect to the signal detector 218 and/or the DSP 220. Further, each of the components illustrated in FIG. 2 can be implemented using a plurality of separate elements.

As discussed above, when executing code, the processing circuit can generate one or more specializations for frequently called functions. In an embodiment, the processing circuit can implement a mechanism to dynamically select one of the specializations, based on runtime input types. In an embodiment, the mechanism can be referred to as a “selector.” When a function is called, the selector can perform type-checks on the function's inputs or arguments.

In an embodiment, the selector can be regenerated when specializations are created or destroyed. When the input types match one of the type signatures, the selector can cause the processing circuit to execute (or jump to) the corresponding specialized version of the function. When the input types do not match a type signature associated with any existing specializations, the selector can choose a non-specialized implementation. In some embodiments, the cost of the selector can be reduced or minimized by performing a reduced or minimal set of checks based on existing specializations. In an embodiment, the number of type checks can be reduced implementing the selector in the form of a decision tree.

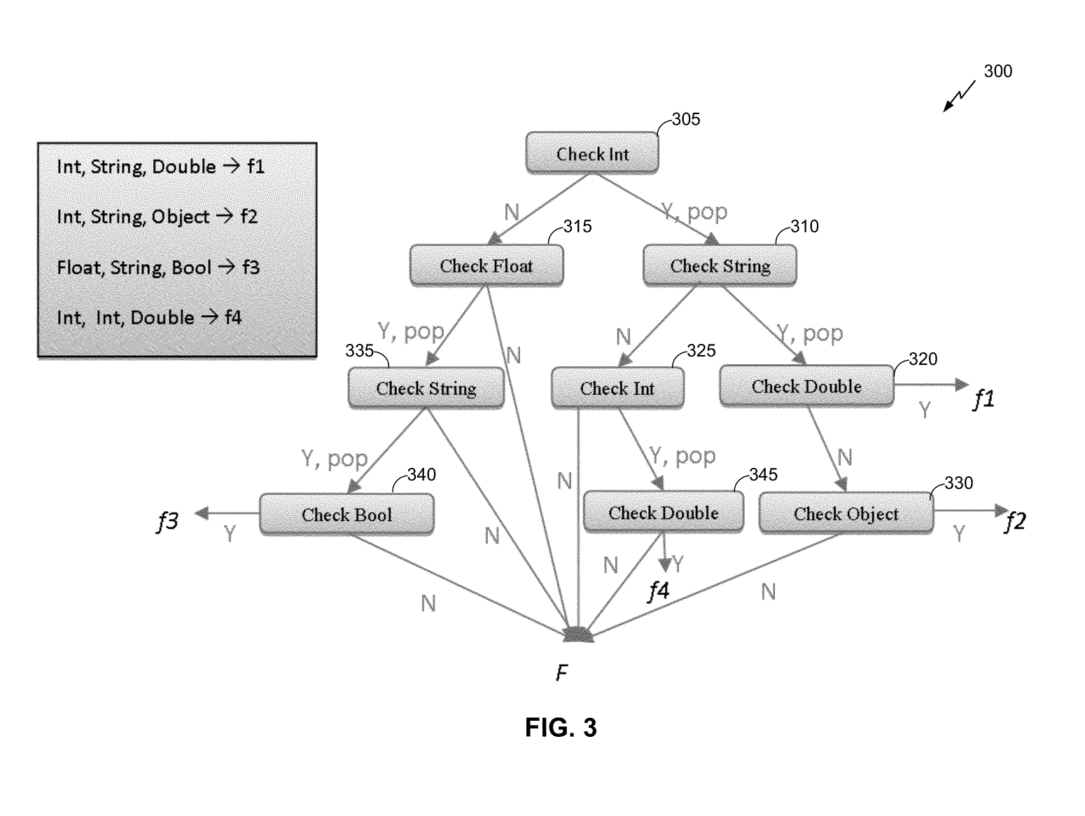

FIG. 3 shows an exemplary decision tree 300 that can be implemented on the device 202 of FIG. 2. In the illustrated embodiment, the processing circuit 204 can generate four specializations f1, f2, f3, and f4, of a generic (or non-specialized) function F. Function F takes up to 3 inputs, each of which can be have a dynamic type such as, for example, Ints, Strings, Doubles, Objects, Floats, Bools, etc.

As shown, the processing circuit 204 generates the specialization f1 based on an input tuple having types (Int, String, Double). The processing circuit 204 generates the specialization f2 based on an input tuple having types (Int, String, Object). The processing circuit 204 generates the specialization f2 based on an input tuple having types (Float, String, Bool). The processing circuit 204 generates the specialization f2 based on an input tuple having types (Int, Int, Double). The four specializations f1, f2, f3, and f4 are exemplary. A person having ordinary skill in the art will appreciate that different, fewer, and/or additional specializations can be generated, for example depending on the particular execution path through a program executed on the processing circuit 204.

When the function F is called, the processing circuit 204 can navigate the decision tree 300 to determine a particular specialization to call. At block 305, the processing circuit 204 checks to see if the first input is an Int. If the first input is an Int, the processing circuit 204 pops the next input off the call stack and proceeds to block 310. If the first input is not an Int, the processing circuit 204 proceeds to block 315.

At block 310, the processing circuit 204 checks to see if the second input is a String. If the second input is a String, the processing circuit 204 pops the next input off the call stack and proceeds to block 320. If the second input is not a String, the processing circuit 204 proceeds to block 325.

At block 320, the processing circuit 204 checks to see if the third input is a Double. If the third input is a Double, the processing circuit 204 can determine that the inputs match the specialization f1. Accordingly, the processing circuit 204 can call the specialization f1. If the third input is not a Double, the processing circuit 204 proceeds to block 330.

At block 330, the processing circuit 204 checks to see if the third input is an Object. If the third input is an Object, the processing circuit 204 can determine that the inputs match the specialization f2. Accordingly, the processing circuit 204 can call the specialization f2. If the third input is not a Object, the processing circuit 204 can determine that the inputs do not match a specialization of the function F. Accordingly, the processing circuit 204 can call the generic function F.

At block 315, the processing circuit 204 checks to see if the first input is a Float. If the first input is a Float, the processing circuit 204 pops the next input off the call stack and proceeds to block 335. If the first input is not a Float, the processing circuit 204 can determine that the inputs do not match a specialization of the function F. Accordingly, the processing circuit 204 can call the generic function F.

At block 335, the processing circuit 204 checks to see if the second input is a String. If the second input is a String, the processing circuit 204 pops the next input off the call stack and proceeds to block 340. If the second input is not a String, the processing circuit 204 can determine that the inputs do not match a specialization of the function F. Accordingly, the processing circuit 204 can call the generic function F.

At block 340, the processing circuit 204 checks to see if the third input is a Bool. If the third input is a Bool, the processing circuit 204 can determine that the inputs match the specialization f3. Accordingly, the processing circuit 204 can call the specialization f3. If the third input is not a Bool, the processing circuit 204 can determine that the inputs do not match a specialization of the function F. Accordingly, the processing circuit 204 can call the generic function F.

At block 325, the processing circuit 204 checks to see if the second input is an Int. If the second input is an Int, the processing circuit 204 pops the next input off the call stack and proceeds to block 345. If the second input is not an Int, the processing circuit 204 can determine that the inputs do not match a specialization of the function F. Accordingly, the processing circuit 204 can call the generic function F.

At block 345, the processing circuit 204 checks to see if the third input is a Double. If the third input is a Double, the processing circuit 204 can determine that the inputs match the specialization f4. Accordingly, the processing circuit 204 can call the specialization f4. If the third input is not a Double, the processing circuit 204 can determine that the inputs do not match a specialization of the function F. Accordingly, the processing circuit 204 can call the generic function F.

As discussed above, the processing circuit 204 can regenerate the decision tree 300 when specializations are created or destroyed. For example, in some embodiments, when the inputs do not match a specialization of the function F, the processing circuit 204 can generate a new specialization rather than calling the generic function F. The processing circuit 204 can update the decision tree 300 according to the new specialization. As another example, when a specialization is not called for threshold period of time, the processing circuit 204 can destroy the specialization and update the decision tree 300. Accordingly, the decision tree 300 can evolve and regenerate as more signatures are added or removed to a list of signatures. In an embodiment, the processing circuit 204 can order the decision tree such that more frequently called specializations are closer to the root of the tree 300.

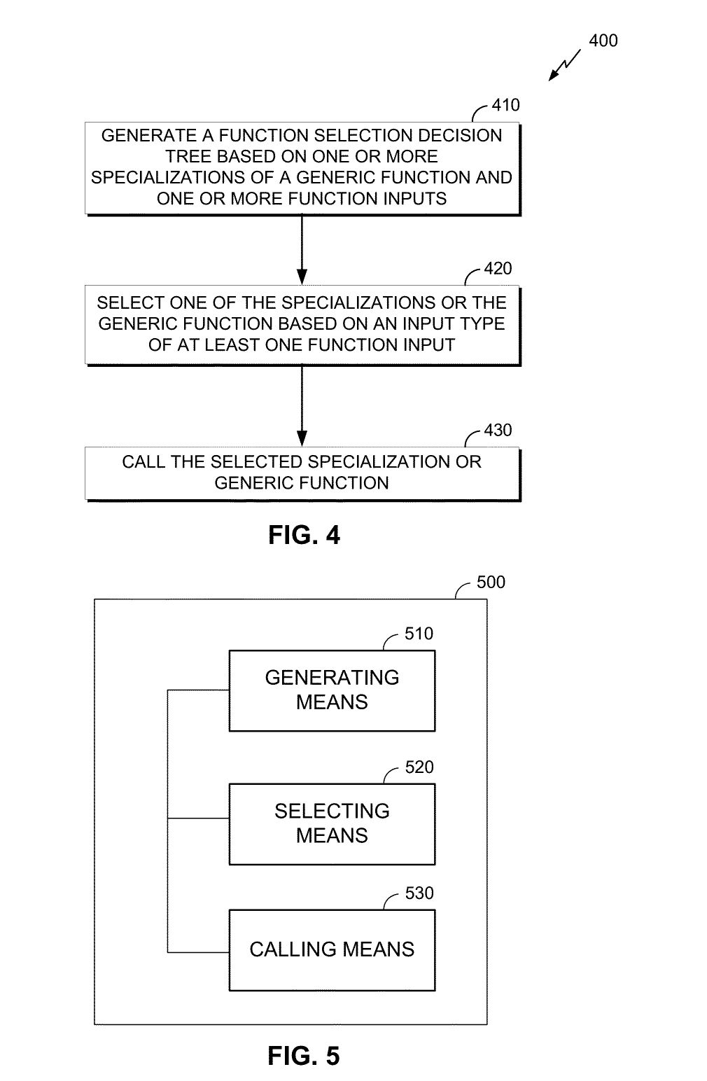

FIG. 4 shows a flowchart 400 of an aspect of an exemplary method of executing a function. In an embodiment, the method can be used to execute a function in a prototype-based dynamically-typed language. Although the flowchart 400 is described below with respect to elements of the wireless device 202 of FIG. 2, those having ordinary skill in the art will appreciate that other components can be used to implement one or more of the blocks described herein. Moreover, although the various blocks of the flowchart 400 are described herein in a particular order, the blocks can be reordered, additional blocks can be inserted, and/or one or more blocks can be removed within the scope of this disclosure.

First, at block 410, the processing circuit 204 generates a function selection decision tree based on one or more specializations of a generic function and one or more function inputs. For example, the processing circuit 204 can generate the decision tree 300 (FIG. 3) based on the specializations f1, f2, f3, and f4, and the first through third inputs to the generic function F.

Next, at block 420, the processing circuit 204 selects one of the specializations, or the generic function, based on an input type of at least one function input. For example, the processing circuit 204 can traverse the decision tree 300 (FIG. 3) and select one of the specializations f1, f2, f3, and f4, or the generic function F, based on whether the first through third inputs have types of Int, Float, String, Double, Object, Bool, etc. As s specific example, the processing circuit 204 can select the specialization f1 when the first input is an Int, the second input is a String, and the third input is a Double. In some embodiments, the processing circuit 204 selects the specialization or generic function based on a subset of inputs (for example, only the first input).

Then, at block 420, the processing circuit 204 calls the selected specialization or generic function. For example, with respect to the exemplary decision tree 300 (FIG. 3), the processing circuit 204 can call the specialization f1 after selecting the specialization f1.

FIG. 5 is a functional block diagram of an exemplary computing device 500 that can implement the method of FIG. 4. Those skilled in the art will appreciate that a computing device may have more components than the simplified computing device 500 shown in FIG. 5. The computing device 500 shown includes only those components useful for describing some prominent features of implementations within the scope of the claims. The device 500 includes a generating means 510, a selecting means 520, and a calling means 530.

In an embodiment, the generating means 510 can be configured to perform one or more of the functions discussed above with respect to the block 410 illustrated in FIG. 4. The generating means 510 can correspond to one or more of the processing circuit 204, the DSP 220, and the memory 206.

In an embodiment, the selecting means 520 can be configured to perform one or more of the functions discussed above with respect to the block 420 illustrated in FIG. 4. The selecting means 520 can correspond to one or more of the processing circuit 204, the DSP 220, and the memory 206.

In an embodiment, the calling means 530 can be configured to perform one or more of the functions discussed above with respect to the block 430 illustrated in FIG. 4. The calling means 530 can correspond to one or more of the processing circuit 204, the DSP 220, and the memory 206.

In addition to number and order of type checks in the selector, another factor affecting selection overhead is the cost associated with each of the checks in the taken path in the tree 300. Different type checks can have different costs. For instance, in the V8 Google JavaScript engine, checking if a value in the stack is small integer can be achieve by examining a single bit in that value. However, if the value is not small integer, the value is used as a pointer to an object in heap whose Map field determines its type (except for Boolean values).

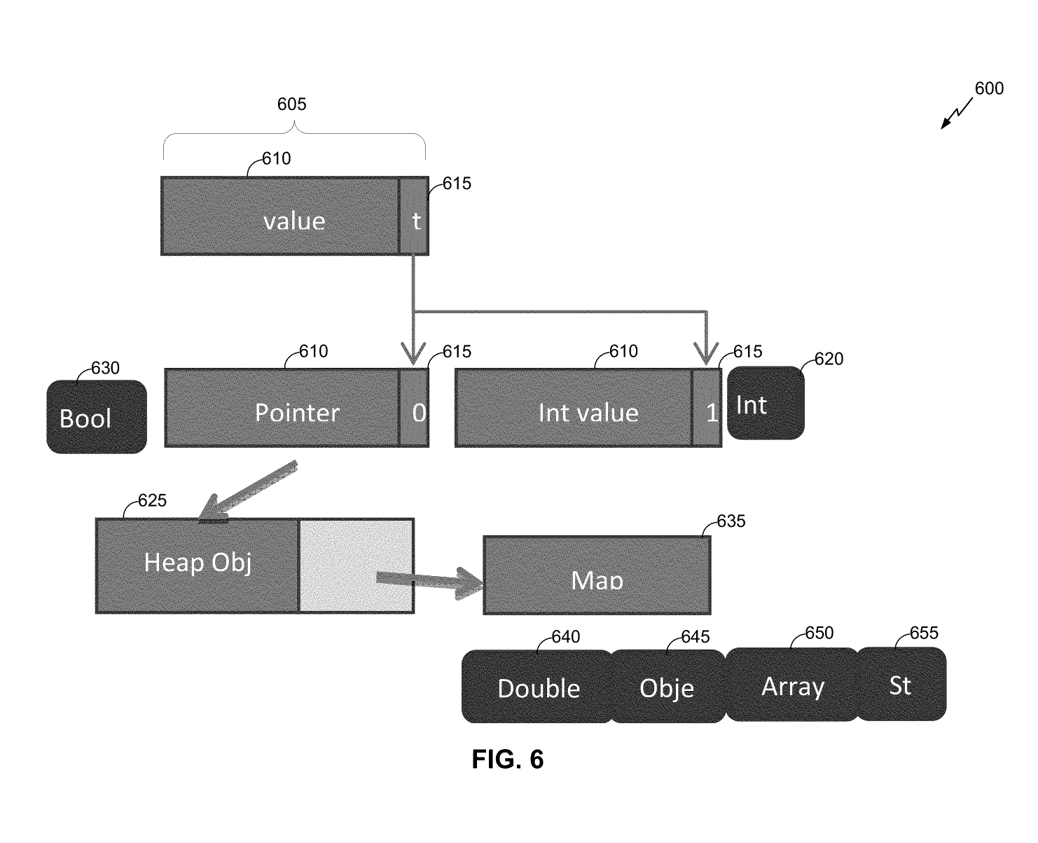

FIG. 6 shows an exemplary type-check process flow 600, according to an embodiment. As shown, a function input 605 can include a value 610 and a type indicator 615. In the illustrated embodiment, a type-indicator 615 of 1 indicates that the value 610 represents a short integer 620. Accordingly, when the type-indicator 615 has a value of 1, the processing circuit 204 (FIG. 2) can interpret the value 610 as a short integer relatively quickly.

A type-indicator 615 of 0 indicates that the value 610 is either a pointer to a heap object 625 or a Boolean 630 (for example, depending on the specific value 610). Where the value 610 is a pointer to the heap object 625, the processing circuit 204 can access retrieve the heap object 625 from the memory 206, which can be relatively slow. The heap object 625 can include a map 635, which can indicate whether the heap object 625 is a Double 640, an Object 645, an Array 650, a String 655, etc.

In an embodiment, the processing circuit 204 (FIG. 2) can simplify the selector by determining one or more prioritized inputs for specialization. For example, the decision tree 300 (FIG. 3) can be generated without reference to a subset of inputs. The processing circuit can use a heuristic algorithm to balance the gain of specialization and the cost of selection (such as, for example, type-checking). Accordingly, the heuristic can decide which inputs should be used for specializations. The processing circuit 204 can assign a weight to each input based on its type and how many times it is used. Inputs with weights below a threshold can be excluded from specialization, both from the inclusion in the signature and the generated function. The specialized function can use a generic type for an excluded input. The selector can check only the types of inputs actually used for specialization. The input weights and threshold can be adjusted based on the target device processing circuit or the language. For example, if the indirect call overhead is high for a given processing circuit, the heuristic can be made more conservative by using a higher threshold value. Advantageously in certain embodiments, selection logic overhead can be reduced using criteria that can utilize different weightages for one or more inputs based on heuristics or runtime information.

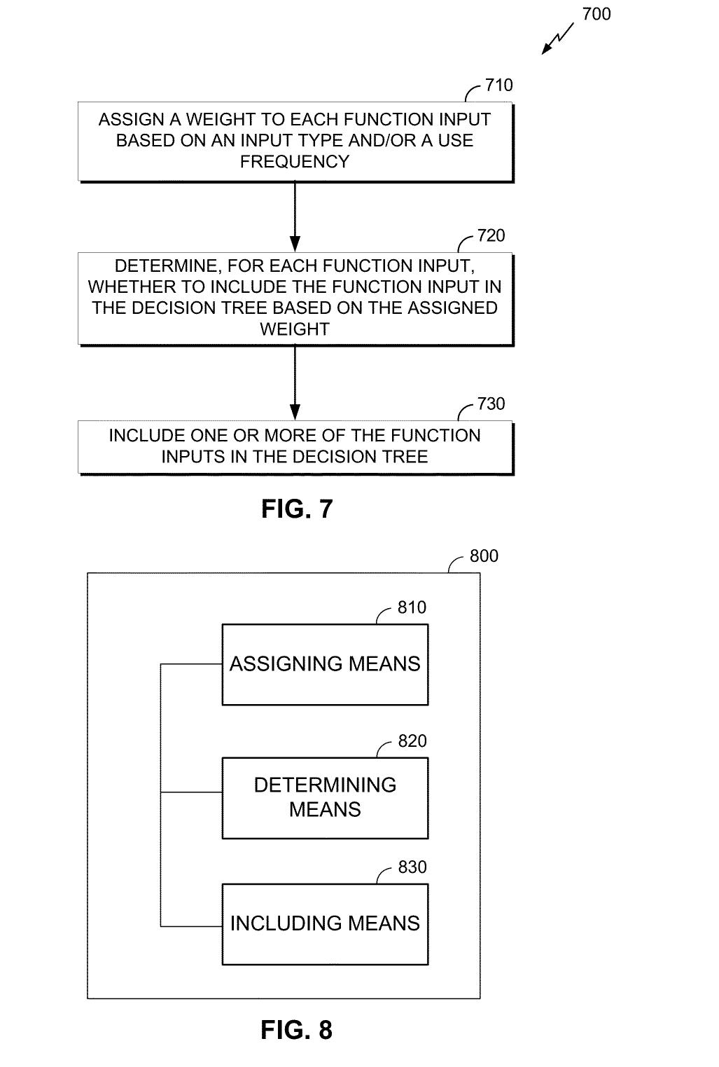

FIG. 7 shows a flowchart 700 of an aspect of an exemplary method of generating the decision tree 300 of FIG. 3. Although the flowchart 700 is described below with respect to elements of the wireless device 202 of FIG. 2, those having ordinary skill in the art will appreciate that other components can be used to implement one or more of the blocks described herein. Moreover, although the various blocks of the flowchart 700 are described herein in a particular order, the blocks can be reordered, additional blocks can be inserted, and/or one or more blocks can be removed within the scope of this disclosure.

First, at block 710, the processing circuit 204 assigns a weight to each function input based on an input type and/or a use frequency. For example, with reference to the generic function F of FIG. 3, the processing circuit 204 can assign a weight of 10 to the first input when the first input is frequently an Int (implying relatively quick type-checking). On the other hand, the processing circuit 204 can assign a weight of 1 to the second input when the second input is frequently a String (implying relatively slow type-checking).

Next, at block 720, the processing circuit 204 determines, for each function input, whether to include the function input in the decision tree based on the assigned weight. For example, the processing circuit 204 can compare each weight to a static or dynamic threshold to determine inclusion in the decision tree 300 (FIG. 3). In particular, the processing circuit 204 can compare the first input, having a weight of 10, to a threshold of 5, and can determine that the first input should be included in the decision tree 300. The processing circuit 204 can compare the second input, having a weight of 1, to the threshold of 5, can determine that the second input should be excluded from the decision tree 300. Accordingly, the processing circuit 204 may not generate or maintain a specialization with respect to the second input.

Then, at block 730, the processing circuit 204 includes one or more of the function inputs, selected for inclusion, in the decision tree. For example, the processing circuit 204 can include the first input of function F in the decision tree 300 (FIG. 3), and can exclude the second input. In an embodiment, including the first input in the decision tree 300 can include generating one or more specialization functions with respect to the first input.

FIG. 8 is a functional block diagram of an exemplary computing device 800 that can implement the method of FIG. 7. Those skilled in the art will appreciate that a computing device may have more components than the simplified computing device 800 shown in FIG. 8. The computing device 800 shown includes only those components useful for describing some prominent features of implementations within the scope of the claims. The device 800 includes an assigning means 810, a determining means 820, and a including means 830.

In an embodiment, the assigning means 810 can be configured to perform one or more of the functions discussed above with respect to the block 710 illustrated in FIG. 7. The processing means 810 can correspond to one or more of the processing circuit 204, the DSP 220, and the memory 206.

In an embodiment, the determining means 820 can be configured to perform one or more of the functions discussed above with respect to the block 720 illustrated in FIG. 7. The determining means 820 can correspond to one or more of the processing circuit 204, the DSP 220, and the memory 206.

In an embodiment, the including means 830 can be configured to perform one or more of the functions discussed above with respect to the block 730 illustrated in FIG. 7. The including means 830 can correspond to one or more of the processing circuit 204, the DSP 220, and the memory 206.

In various embodiments, functions which call a specialized function (callers) may have full or partial type information about the values passed to the specialized function (callee). In various embodiments, the processing circuit 204 (FIG. 2) can gather this type information using static type inference or by executing type checks elsewhere in the code. In such cases, a selector can be bypassed or excluded.

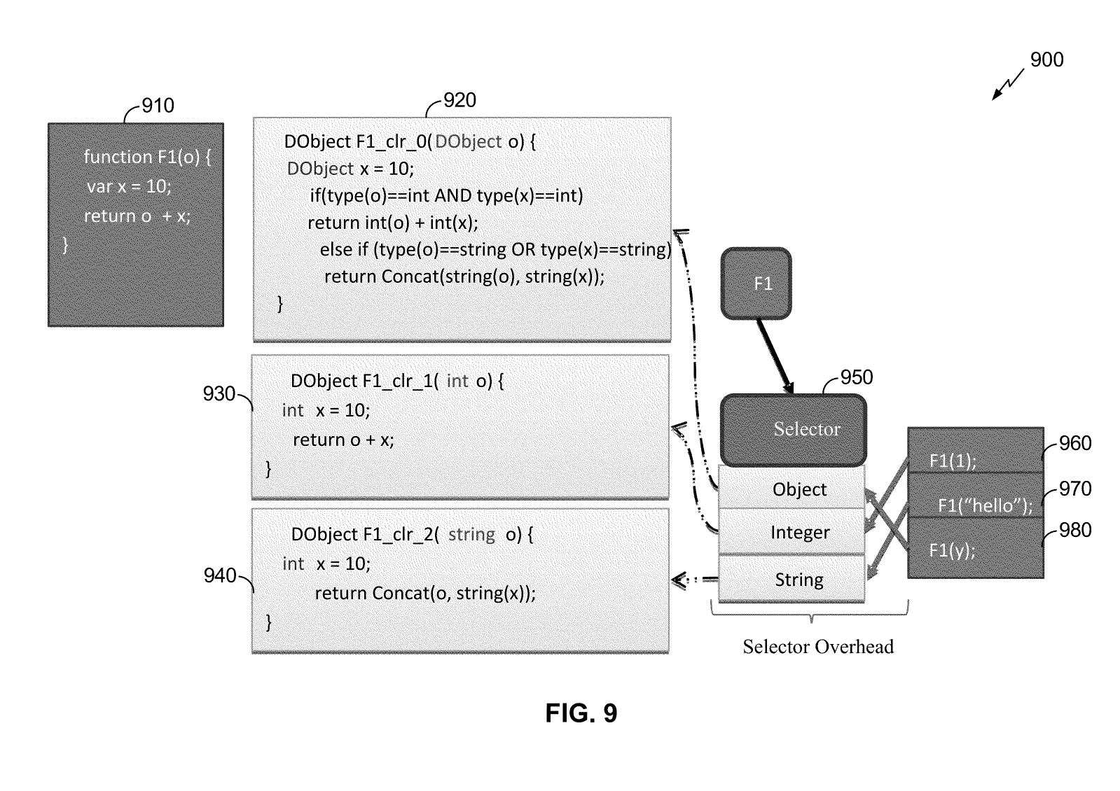

FIG. 9 shows a signature-based type specialization system 900 without direct call sites. In the illustrated embodiment, a function F1 has a generic function 910, an Object-specialized function 920, an Integer-specialized function 930, and a String-specialized function 940. A selector 950 is configured to direct three function calls 960, 970, and 980 to the appropriate specialization 920, 930, and 940. In an embodiment, the selector 950 can include a decision tree such as the decision tree 300 of FIG. 3. Because the processing circuit 204 (FIG. 2) executes the selector 950 code during the function calls 960, 970, and 980, there is some selector overhead.

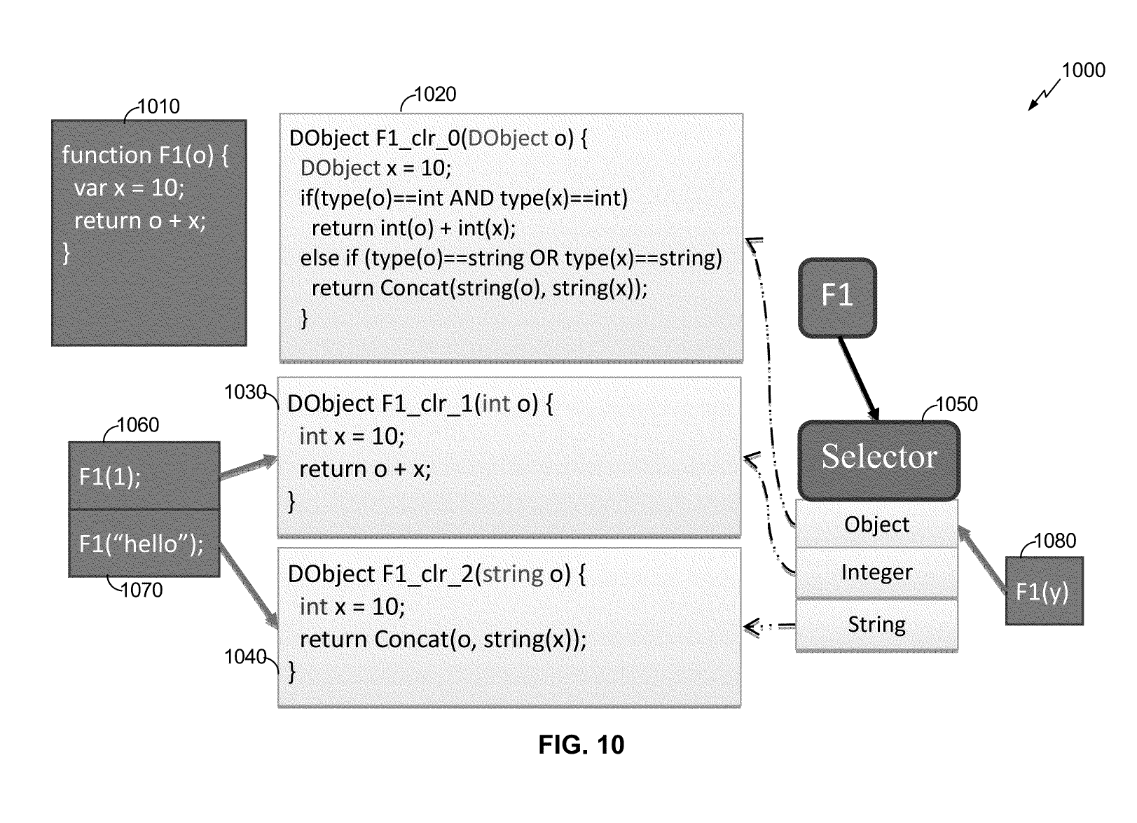

FIG. 10 shows a signature-based type specialization system 1000 with direct call sites. In the illustrated embodiment, a function F1 has a generic function 1010, an Object-specialized function 1020, an Integer-specialized function 1030, and a String-specialized function 1040. A selector 1050 is configured to direct three function calls 1060, 1070, and 1080 to the appropriate specialization 1020, 1030, and 1040. In an embodiment, the selector 1050 can include a decision tree such as the decision tree 300 of FIG. 3. In contrast to the system 900 without direct call sites, discussed above with respect to FIG. 9, in the system 1000, the function calls 1060 and 1070 can directly reference the specialized functions 1030 and 1040. Accordingly, there is no selector overhead. In some embodiments, one or more function calls such as the function call 1080 can continue to call the selector 1050.

Since specializations may be created or destroyed as a program executes, the correct callee specialization (such as the Integer-specialized function 1030) may not be known when a caller function (such as the caller 1060) is compiled. In an embodiment, the processing circuit 204 can maintain a list of call sites. The list can be maintained at the callee function. Entries in this list can be added or removed during JIT compilation, for example when a specialization for the callee function is created or destroyed. When the list is updated, the processing circuit 204 can modify call sites to reference one or more of the appropriate specialization, a generalized implementation, a simplified selector which only checks the types of unknown inputs, and the callee's general selector. In garbage-collected languages, the list of call sites can include weak references to enable the garbage collector to reclaim memory containing caller code.

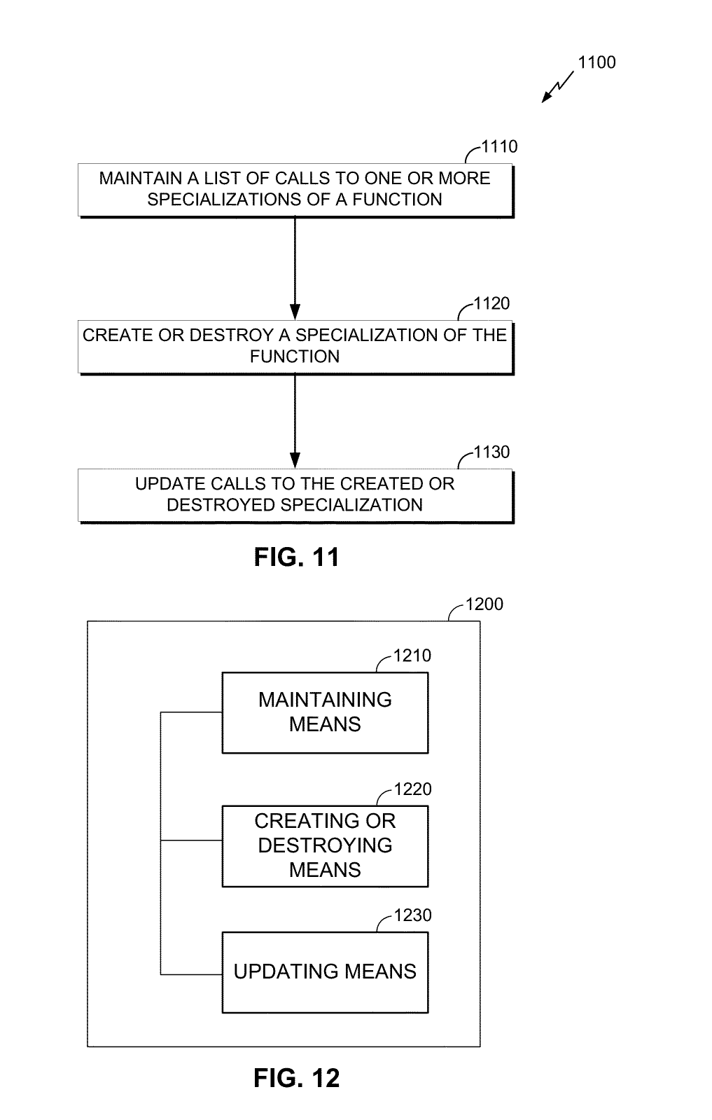

FIG. 11 shows a flowchart 1100 of an aspect of an exemplary method of executing a function. In an embodiment, the method can be used to execute a function in a prototype-based dynamically-typed language. Although the flowchart 1100 is described below with respect to elements of the wireless device 202 of FIG. 2, those having ordinary skill in the art will appreciate that other components can be used to implement one or more of the blocks described herein. Moreover, although the various blocks of the flowchart 1100 are described herein in a particular order, the blocks can be reordered, additional blocks can be inserted, and/or one or more blocks can be removed within the scope of this disclosure.

First, at block 1110, the processing circuit 204 maintains a list of direct calls to one or more specializations of a function. For example, with reference to the signature-based type specialization system 1000 of FIG. 10, the processing circuit 204 can maintain a list of direct calls 1060 and 1070 to the specialized functions 1030 and 1040.

Next, at block 1120, the processing circuit 204 creates or destroys a specialization of the function. For example, the processing circuit 204 can destroy the Integer-specialized function 1030. As another example, the processing circuit 204 can create the Object-specialized function 1020.

Then, at block 1130, the processing circuit 204 updates calls to the created or destroyed specialization. For example, when the processing circuit 204 destroys the Integer-specialized function 1030, it can look up the function call 1060. The processing circuit 204 can update the function call 1060, for example, to call the selector 1050. As another example, when the processing circuit 204 creates the Object-specialized function 1020, it can look up the function call 1080. The processing circuit 204 can update the function call 1080 to directly call the specialization 1020.

FIG. 12 is a functional block diagram of an exemplary computing device 1200 that can implement the method of FIG. 11. Those skilled in the art will appreciate that a computing device may have more components than the simplified computing device 1200 shown in FIG. 12. The computing device 1200 shown includes only those components useful for describing some prominent features of implementations within the scope of the claims. The device 1200 includes a maintaining means 1210, a creating means 1220, and an updating means 1230.

In an embodiment, the maintaining means 1210 can be configured to perform one or more of the functions discussed above with respect to the block 1110 illustrated in FIG. 11. The maintaining means 1210 can correspond to one or more of the processing circuit 204, the DSP 220, and the memory 206.

In an embodiment, the creating means 1220 can be configured to perform one or more of the functions discussed above with respect to the block 1120 illustrated in FIG. 11. The creating means 1220 can correspond to one or more of the processing circuit 204, the DSP 220, and the memory 206.

In an embodiment, the updating means 1230 can be configured to perform one or more of the functions discussed above with respect to the block 1130 illustrated in FIG. 11. The updating means 1230 can correspond to one or more of the processing circuit 204, the DSP 220, and the memory 206.

As used herein, the term “determining” encompasses a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. Further, a “channel width” as used herein can encompass or can also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processing circuit, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processing circuit can be a microprocessor, but in the alternative, the processing circuit can be any commercially available processing circuit, controller, microcontroller or state machine. A processing circuit can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium can include non-transitory computer readable medium (e.g., tangible media). In addition, in some aspects computer readable medium can include transitory computer readable medium (e.g., a signal). Combinations of the above should also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

The functions described can be implemented in hardware, software, firmware or any combination thereof. If implemented in software, the functions can be stored as one or more instructions on a computer-readable medium. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects can include a computer program product for performing the operations presented herein. For example, such a computer program product can include a computer readable medium having instructions stored (and/or encoded) thereon, the instructions being executable by one or more processing circuits to perform the operations described herein. For certain aspects, the computer program product can include packaging material.

Software or instructions can also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations can be made in the arrangement, operation and details of the methods and apparatus described above without departing from the scope of the claims.

While the foregoing is directed to aspects of the present disclosure, other and further aspects of the disclosure can be devised without departing from the basic scope thereof, and the scope thereof is determined by the claims that follow.

What is claimed is:

1. A method of executing a function in a prototype-based dynamically-typed language, comprising:
generating a function selection decision tree based on one or more specializations of a generic function and one or more function inputs via an electronic device;
selecting one of the specializations or the generic function based on an input type of at least one function input via the electronic device; and
calling the selected specialization or generic function via the electronic device.

2. The method of claim 1, wherein generating the function selection decision tree comprises:
assigning a weight to each function input based on an input type and/or a use frequency;
determining, for each function input, whether to include the function input in the decision tree based on the assigned weight; and
including one or more of the function inputs in the decision tree.

3. The method of claim 1, further comprising:
creating or destroying a specialization via the electronic device; and
regenerating the decision tree via the electronic device.

4. The method of claim 1, further comprising prioritizing one or more function inputs via the electronic device.

5. The method of claim 2, wherein assigning the weight comprises applying a weighting heuristic.

6. The method of claim 2, further comprising omitting at least one function input from the decision tree.

7. The method of claim 6, wherein omitting at least one function input includes refraining from generating a specialization function with respect to the at least one omitted function input.

8. A method of executing a function in a prototype-based dynamically-typed language, comprising:
maintaining a list of calls to one or more specializations of the function via an electronic device;
creating or destroying a specialization of the function via the electronic device; and
updating calls to the created or destroyed specialization via the electronic device.

9. The method of claim 8, wherein at least one call in the list comprises a direct call.

10. The method of claim 8, wherein updating calls comprises modifying the calls to reference one of a specialization function, a generalized implementation, a simplified selector configured to check only the types of unknown inputs, and a function's general selector.

11. A device configured to execute a function in a prototype-based dynamically-typed language, comprising:
a memory; and
a processing circuit configured to:
generate a function selection decision tree based on one or more specializations of a generic function and one or more function inputs;
select one of the specializations or the generic function based on an input type of at least one function input; and
call the selected specialization or generic function.

12. The device of claim 11, wherein the processing circuit is configured to generate the function selection decision tree by:
assigning a weight to each function input based on an input type and/or a use frequency;
determining, for each function input, whether to include the function input in the decision tree based on the assigned weight; and
including one or more of the function inputs in the decision tree.

13. The device of claim 11, wherein the processing circuit is further configured to:
create or destroy a specialization; and
regenerate the decision tree.

14. The device of claim 11, wherein the processing circuit is further configured to prioritize one or more function inputs.

15. The device of claim 12, wherein assigning the weight comprises applying a weighting heuristic.

16. The device of claim 12, wherein the processing circuit is further configured to omit at least one function input from the decision tree.

17. The device of claim 16, wherein the processing circuit is further configured to refrain from generating a specialization function with respect to the at least one omitted function input.

18. A device configured to execute a function in a prototype-based dynamically-typed language, comprising:
a memory; and
a processing circuit configured to:
maintain a list of calls to one or more specializations of the function;
create or destroy a specialization of the function; and
update calls to the created or destroyed specialization.

19. The device of claim 18, wherein at least one call in the list comprises a direct call.

20. The device of claim 18, wherein the processing circuit is configured to update calls by modifying the calls to reference one of a specialization function, a generalized implementation, a simplified selector configured to check only the types of unknown inputs, and a function's general selector.

21. An apparatus for executing a function in a prototype-based dynamically-typed language, comprising:
means for generating a function selection decision tree based on one or more specializations of a generic function and one or more function inputs;
means for selecting one of the specializations or the generic function based on an input type of at least one function input; and
means for calling the selected specialization or generic function.

22. The apparatus of claim 21, wherein generating the function selection decision tree comprises:
means for assigning a weight to each function input based on an input type and/or a use frequency;
means for determining, for each function input, whether to include the function input in the decision tree based on the assigned weight; and
means for including one or more of the function inputs in the decision tree.

23. The apparatus of claim 21, further comprising:
means for creating or destroying a specialization; and
means for regenerating the decision tree.

24. The apparatus of claim 21, further comprising means for prioritizing one or more function inputs.

25. The apparatus of claim 22, wherein means for assigning the weight comprises means for applying a weighting heuristic.

26. The apparatus of claim 22, further comprising means for omitting at least one function input from the decision tree.

27. The apparatus of claim 26, wherein means for omitting at least one function input includes means for refraining from generating a specialization function with respect to the at least one omitted function input.

28. An apparatus for executing a function in a prototype-based dynamically-typed language, comprising:
means for maintaining a list of calls to one or more specializations of the function;
means for creating or destroying a specialization of the function; and
means for updating calls to the created or destroyed specialization.

29. The apparatus of claim 28, wherein at least one call in the list comprises a direct call.

30. The apparatus of claim 28, wherein means for updating calls comprises means for modifying the calls to reference one of a specialization function, a generalized implementation, a simplified selector configured to check only the types of unknown inputs, and a function's general selector.

31. A non-transitory computer-readable medium comprising code that, when executed, causes an apparatus to:
generate a function selection decision tree based on one or more specializations of a generic function and one or more function inputs;
select one of the specializations or the generic function based on an input type of at least one function input; and
call the selected specialization or generic function.

32. The medium of claim 31, wherein generating the function selection decision tree comprises:
assigning a weight to each function input based on an input type and/or a use frequency;
determining, for each function input, whether to include the function input in the decision tree based on the assigned weight; and
including one or more of the function inputs in the decision tree.

33. The medium of claim 31, further comprising code that, when executed, causes the apparatus to:
create or destroying a specialization; and
regenerate the decision tree.

34. The medium of claim 31, further comprising code that, when executed, causes the apparatus to prioritize one or more function inputs.

35. The medium of claim 32, wherein assigning the weight comprises applying a weighting heuristic.

36. The medium of claim 32, further comprising code that, when executed, causes the apparatus to omit at least one function input from the decision tree.

37. The medium of claim 36, wherein omitting at least one function input includes refraining from generating a specialization function with respect to the at least one omitted function input.

38. A non-transitory computer-readable medium comprising code that, when executed, causes an apparatus to:
maintain a list of calls to one or more specializations of the function;
create or destroy a specialization of the function; and
update calls to the created or destroyed specialization.

39. The medium of claim 38, wherein at least one call in the list comprises a direct call.

40. The medium of claim 38, wherein updating calls comprises modifying the calls to reference one of a specialization function, a generalized implementation, a simplified selector configured to check only the types of unknown inputs, and a function's general selector.
